(19) United States
(12) Patent Application Publication
(10) Pub. No.: US 2026/0328224 A1
(43) Pub. Date: Oct. 22, 2026

(54) MAGNETIC SUCTION FAN

(71) Applicant: Ning XU, Shenzhen City (CN)

(72) Inventor: Ning XU, Shenzhen City (CN)

(73) Assignee: Shenzhen Giikfun Technology Co., Ltd., Shenzhen (CN)

(21) Appl. No.: 19/294,260

(22) Filed: Aug. 7, 2025

(51) Int. Cl. F04D 29/64; F04D 19/00; H01F 7/02

(52) U.S. Cl. CPC F04D 29/646; F04D 19/002; H01F 7/02

(57) ABSTRACT

A magnetic suction fan designed for golf carts includes a fan assembly, a base and a magnetic element. The fan assembly converts electrical energy into mechanical energy for driving airflow. The base is rigidly fixed to the fan assembly, and the magnetic element is arranged on the base with its magnetic working surface providing a planar pulling force greater than 10 kg to maintain stable adhesion to ferromagnetic surfaces during golf cart vibration. Through this configuration, the magnetic suction fan of the present disclosure is optimized for golf cart applications, with all components working synergistically to unify functionality, installation, and stability. The fan assembly converts electrical energy into airflow to meet ventilation needs; the rigidly fixed connection between the base and the fan assembly prevents loosening due to vibration, ensuring safety. These features ensure reliable operation and user convenience in golf cart environments.

### TECHNICAL FIELD

The present disclosure relates to the technical field of portable fans, and in particular, to a high-vibration-resistant magnetic suction fan for golf carts.

### BACKGROUND OF THE INVENTION

In outdoor sports applications, golf carts serving as player transport vehicles frequently operate for extended periods under intense sunlight, necessitating fans as essential accessories to deliver continuous airflow and mitigate heat buildup. Conventional golf cart fans typically employ strap fastening or mechanical clamp fixation approaches, which exhibit notable deficiencies. The sustained vibrations encountered when navigating grassy slopes and gravel-covered paths often induce strap slackening or clamp shifting, resulting in fan instability or complete detachment that requires users to repeatedly stop the golf cart for manual readjustment. Although existing magnetic suction fans offer simplified installation, their magnetic elements generally demonstrate inadequate adhesive force (typically less than 5 kg), leaving them susceptible to fixation failure when subjected to the high-frequency vibration characteristic of golf cart operation.

These issues critically impair user experience: an unstably fixed fan not only diminishes airflow efficiency but may also detach unexpectedly during operation over rough terrain, posing risks of equipment damage and potential safety hazards. To overcome these limitations of conventional designs, the present disclosure provides a high-stability magnetic suction fan that effectively solves the vibration-induced fixation reliability problem through innovative magnetic structure and optimized anti-vibration design.

### SUMMARY OF THE INVENTION

In order to overcome the shortcomings of the prior art, the present disclosure provides a magnetic suction fan with a simple structure that effectively resolves unreliable fixation in vibrational environments.

The technical solution adopted by the present disclosure to solve the technical problem is as follows.

A magnetic suction fan for a golf cart, including: a fan assembly configured to convert electrical energy into mechanical energy for driving airflow, including: a base rigidly fixed to the fan assembly; and a magnetic element arranged on the base and configured to magnetically secure the base to a ferromagnetic surface of the golf cart, the magnetic element includes a magnetic working surface providing a planar pulling force greater than 10 kg to maintain fixation of the base during vibration of the golf cart.

As an improvement of the present disclosure, the base is provided with a mounting groove configured to match an external profile of the magnetic element, and the magnetic element is embedded and fixedly connected to the mounting groove.

As an improvement of the present disclosure, the magnetic suction fan further including a connecting element, the magnetic element is fixedly connected within the mounting groove via the connecting element.

As an improvement of the present disclosure, the magnetic element is provided with a mounting through-hole, and the connecting element extends through the mounting through-hole and is fixedly connected to the mounting groove.

As an improvement of the present disclosure, a bottom of the mounting groove is provided with a connecting through-hole, and the connecting element extends through both the mounting through-hole and the connecting through-hole to threadably secure the magnetic element within the mounting groove.

As an improvement of the present disclosure, the connecting element includes a threaded fastener and a connecting nut; a nut mounting groove is arranged on a side of the connecting through-hole away from the magnetic element; the connecting nut is received and rotationally constrained within the nut mounting groove; and the threaded fastener sequentially extends through the mounting through-hole and the connecting through-hole to threadably engage with the connecting nut, thereby securing the magnetic element.

As an improvement of the present disclosure, the connecting element is a threaded fastener; a connecting post is arranged at the bottom of the mounting groove and integrally formed with the base; an internally threaded blind hole is formed at a top end of the connecting post; and the threaded fastener extends through the mounting through-hole and threadably engages the internally threaded blind hole to fixedly connect the magnetic element within the mounting groove.

As an improvement of the present disclosure, an auxiliary adhesive layer is arranged between contacting surfaces of the mounting groove and the magnetic element, and the auxiliary adhesive layer is configured to enhance vibration resistance performance.

As an improvement of the present disclosure, the base includes a fan mounting portion; the fan assembly includes a fan bracket; and the fan bracket is integrally formed with the fan mounting portion.

As an improvement of the present disclosure, the fan assembly further includes a fan main body, and the fan main body is rotatably connected to the fan bracket.

As an improvement of the present disclosure, the base further includes a fan clamp body, and the fan clamp body is rotatably connected to the fan mounting portion.

As an improvement of the present disclosure, the magnetic element is a countersunk pot magnet including a permanent magnet formed of sintered neodymium-iron-boron material; a steel housing encapsulating sidewalls and a bottom surface of the permanent magnet and forming the magnetic working surface on a single side; and a countersunk hole formed at a center of the steel housing, the countersunk hole having a taper matching the threaded fastener for flush securing the countersunk pot magnet to the base.

As an improvement of the present disclosure, the base is further provided with an anti-slip element arranged around the magnetic element.

As an improvement of the present disclosure, the anti-slip element includes a mounting surface fixedly connected to the base; and an anti-slip surface configured to protrude slightly beyond the magnetic working surface when the mounting surface is fixedly connected to the base.

As an improvement of the present disclosure, the magnetic element is at least one in number.

As an improvement of the present disclosure, the magnetic working surface provides the planar pulling force greater than 40 kg to maintain fixation of the base under vibrational conditions during operation of the golf cart.

As an improvement of the present disclosure, the fan main body includes a fan snap-fit portion; and a snap-fit element; the fan bracket is provided with a bracket mounting portion; and the fan snap-fit portion is rotatably connected to the fan bracket via the snap-fit element.

As an improvement of the present disclosure, the fan main body further includes a control circuit board; a rechargeable power source; and a charging port.

As an improvement of the present disclosure, the fan main body further includes a discharging port.

As an improvement of the present disclosure, the fan main body further includes at least one control button.

The beneficial effects of the present disclosure are as follows: With the above-described configuration, during operation, the magnetic working surface of the magnetic element provides a planar pulling force greater than 10 kg, magnetically securing the base to the ferromagnetic surface of the golf cart. Even under the continuous vibrational environment occurring on bumpy roads, the base can maintain fixation without displacement, thereby effectively eliminating the risk of detachment caused by loosening of traditional straps or magnetic suction failure. The base is rigidly connected to the fan assembly, which ensures that vibrational energy is isolated by the base-magnetic element system and prevented from being transmitted to the fan assembly, thereby avoiding adverse effects on airflow delivery stability. The fan assembly continuously converts electrical energy into uniform and stable airflow, providing passengers with a cool and comfortable airflow experience, and significantly improving the endurance of golfers in high-temperature environments.

### BRIEF DESCRIPTION OF DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic structural view of the magnetic suction fan according to Embodiment 1 of the present disclosure from a first perspective;

FIG. 2 is a schematic structural view of the magnetic suction fan according to Embodiment 1 of the present disclosure from a second perspective;

FIG. 3 is a cross-sectional view of the magnetic suction fan according to Embodiment 1 of the present disclosure;

FIG. 4 is an exploded view of the magnetic suction fan according to Embodiment 1 of the present disclosure from the first perspective;

FIG. 5 is an exploded view of the magnetic suction fan according to Embodiment 1 of the present disclosure from the second perspective;

FIG. 6 is an exploded view of the fan main body 120 according to Embodiment 1 of the present disclosure from the first perspective;

FIG. 7 is an exploded view of the fan main body 120 according to Embodiment 1 of the present disclosure from the second perspective;

FIG. 8 is a schematic structural view of the magnetic suction fan according to Embodiment 2 of the present disclosure;

FIG. 9 is an exploded view of the magnetic suction fan according to Embodiment 2 of the present disclosure;

FIG. 10 is a schematic structural view of the magnetic suction fan according to Embodiment 3 of the present disclosure from the first perspective;

FIG. 11 is a schematic structural view of the magnetic suction fan according to Embodiment 3 of the present disclosure from the second perspective; and

FIG. 12 is an exploded view of the magnetic suction fan according to Embodiment 3 of the present disclosure.

### DETAILED DESCRIPTION OF THE INVENTION

To make the aforementioned objectives, features, and advantages of the present disclosure more comprehensible, specific implementations of the present disclosure are described in detail below in conjunction with the accompanying drawings. In the following description, numerous specific details are set forth to provide a thorough understanding of the present disclosure. The present disclosure may, however, be embodied in many forms different from that described here. A person skilled in the art can make similar improvements without departing from the connotation of the present disclosure. Therefore, the present disclosure is not limited by the specific embodiments disclosed below.

In the description of the present disclosure, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present disclosure and simplifying the description, Rather than indicating or implying that the indicated device or element must have a particular orientation, be constructed and operated in a particular orientation, therefore, not to be construed as limiting the present disclosure.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present disclosure, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present disclosure can be understood based on specific circumstances.

In the present disclosure, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

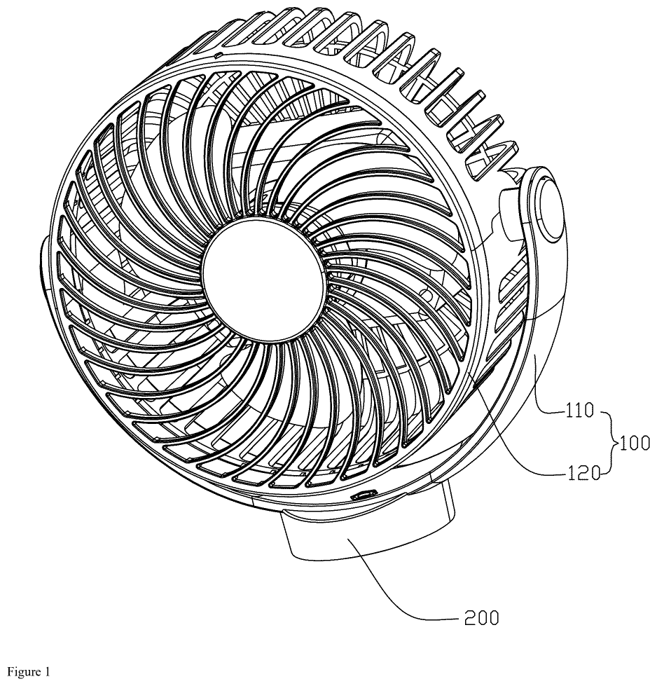

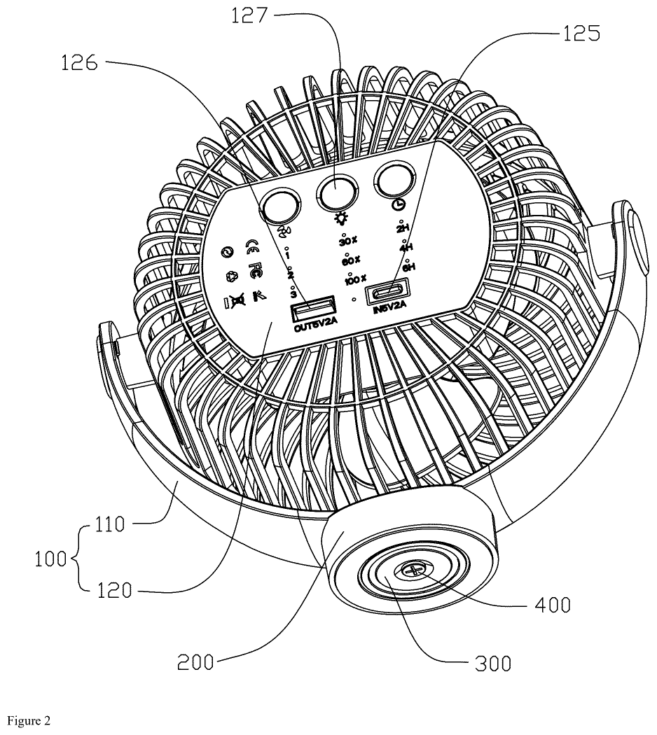

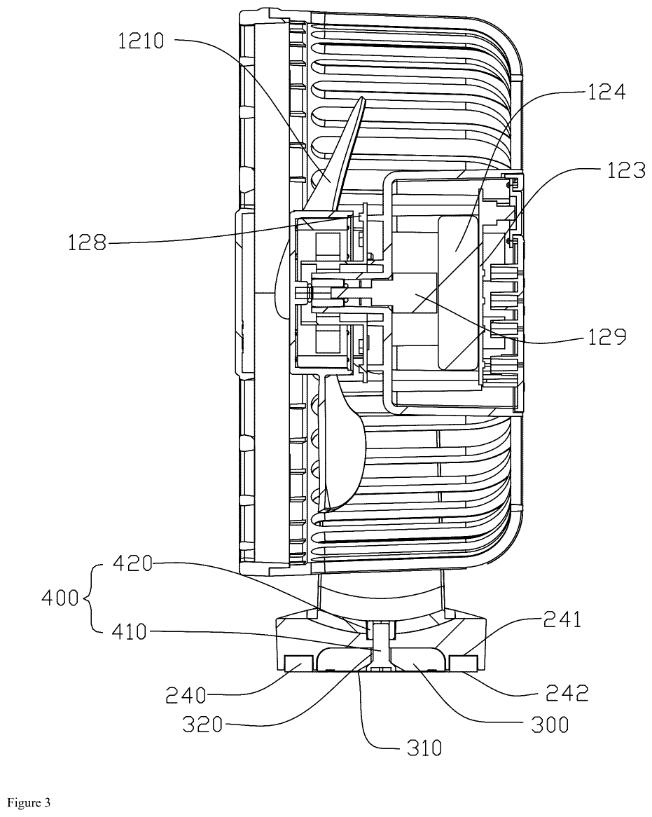

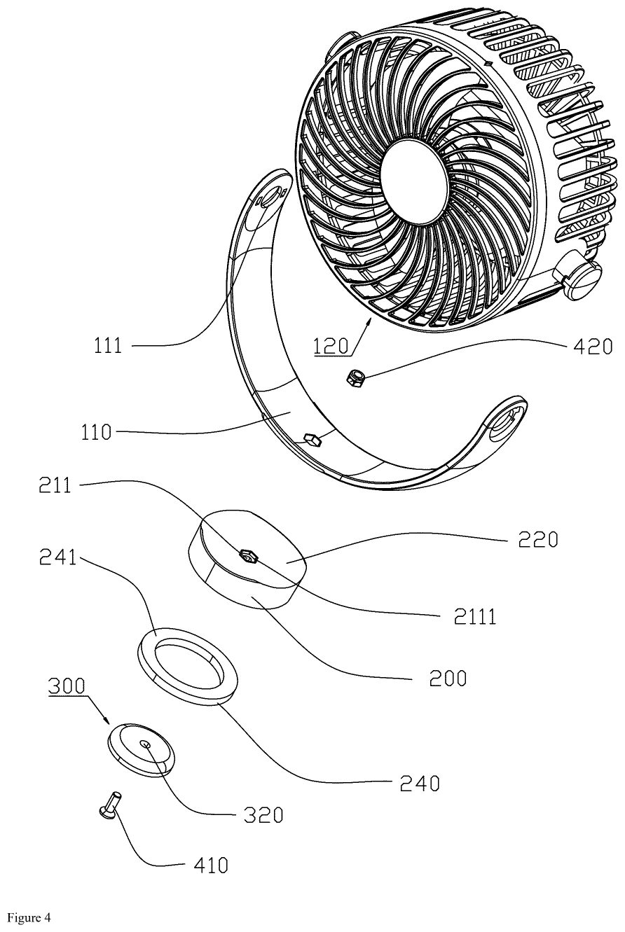

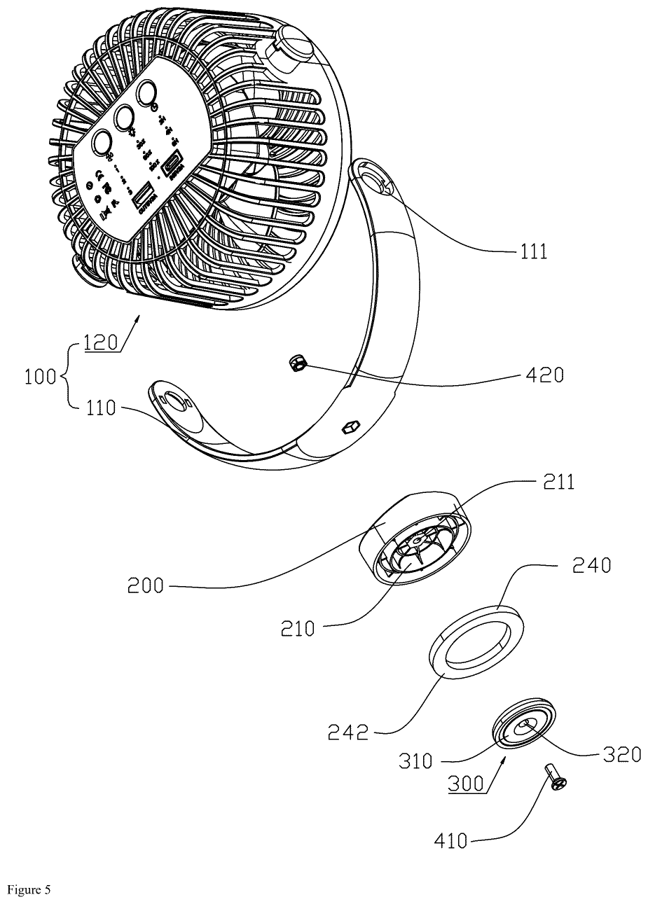

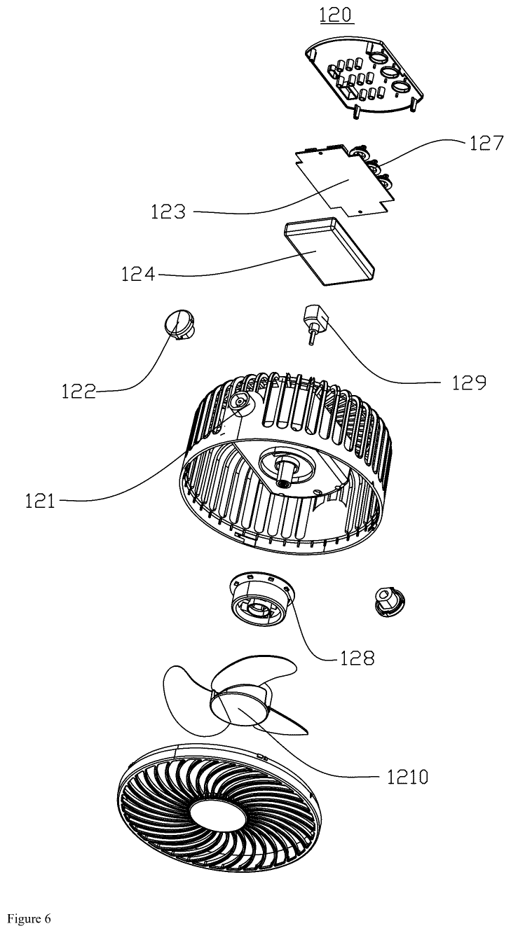

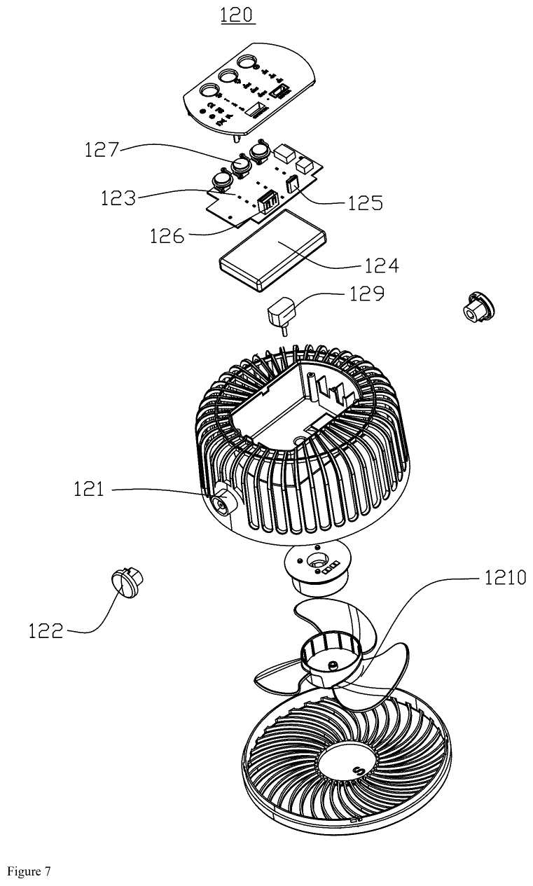

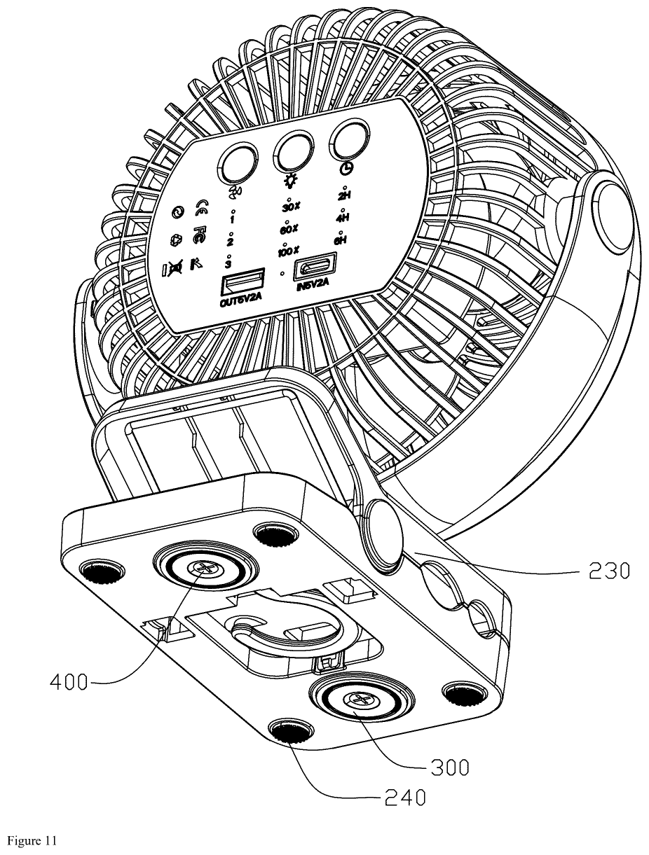

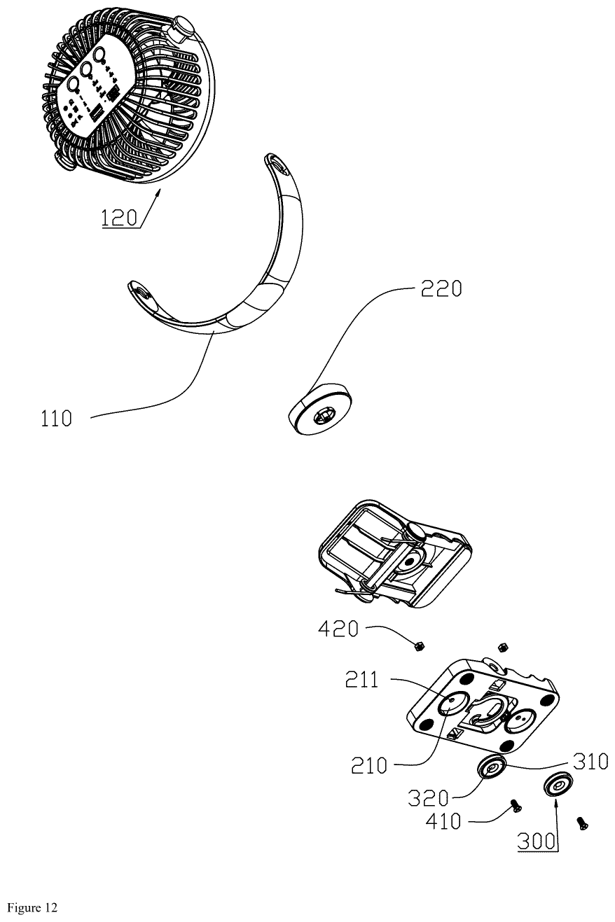

Referring to FIGS. 1 to 12, a magnetic suction fan for a golf cart, includes:
a fan assembly 100 configured to convert electrical energy into mechanical energy for driving airflow;
a base 200 rigidly fixed to the fan assembly 100; and
a magnetic element 300 arranged on the base 200 and configured to magnetically secure the base 200 to a ferromagnetic surface of the golf cart, wherein the magnetic element 300 includes a magnetic working surface 310 that provides a planar pulling force greater than 10 kg to maintain fixation of the base 200 during vibration of the golf cart.

With the above-described configuration, during operation, the magnetic working surface 310 of the magnetic element 300 provides the planar pulling force greater than 10 kg, securing the base 200 firmly to the ferromagnetic surface of the golf cart. Even under sustained vibrational conditions generated when traversing rough terrain, the base 200 maintains fixed positioning without displacement. The base 200 is rigidly fixed to the fan assembly 100, forming an integrated rigid structure that prevents relative displacement. This configuration ensures vibrational energy is isolated and absorbed by the base 200 and the magnetic element 300 system, effectively preventing transmission to the fan assembly 100. When vibrational energy from golf cart motion is transmitted through the ferromagnetic surface to the magnetic element 300, the energy is primarily directed into the base 200. Pursuant to mechanical impedance mismatch principles, the majority of vibrational energy is reflected at the interface. Residual energy is dissipated as heat through the high damping characteristics of the base 200-magnetic element 300 composite structure (via magnetic domain wall motion and internal material friction). This design achieves vibration transmissibility of just 0.15-0.4 within the 5-50 Hz operational frequency range (representing a 60%-85% reduction compared to flexible connections). The effective isolation and absorption of vibrational energy prevents transmission to the fan assembly 100, thereby eliminating risks of component loosening or airflow instability. The fan assembly 100 continuously converts electrical energy into mechanical energy for driving airflow, delivering stable and robust air circulation that provides golf cart occupants with consistent cooling comfort.

In this embodiment, the base 200 is provided with a mounting groove 210 configured to match an external profile of the magnetic element 300, and the magnetic element 300 is embedded and fixedly connected to the mounting groove 210. With the above-described configuration, during installation the magnetic element 300 is precisely embedded into the mounting groove 210 of the base 200 by means of profile matching to achieve rapid positioning without requiring manual alignment adjustment. During operation, the mounting groove 210 imposes circumferential constraints on the magnetic element 300 to prevent any micro-movement relative to the base 200 under vibrational conditions, thereby ensuring the magnetic working surface 310 maintains full uninterrupted contact with the golf cart's ferromagnetic surface. The fixed connection forms an integral rigid structure between the magnetic element 300 and base 200 that collectively withstands operational vibration impacts while consistently maintaining the sustained adhesive effect with the planar pulling force greater than 10 kg, thereby reducing detachment risk of the magnetic suction fan.

In this embodiment, the magnetic suction fan further includes a connecting element 400, and the magnetic element 300 is fixedly connected within the mounting groove 210 via the connecting element 400. With the above-described configuration, during installation, the connecting element 400 positively secures the magnetic element 300 within the mounting groove 210 without waiting for adhesive curing, thereby improving assembly efficiency. During operation, the connecting element 400 applies a continuous preload to the magnetic element 300 to eliminate assembly clearance between the base 200 and the magnetic element 300, enabling them to maintain a rigid integrated state at all times during vehicle vibration and ensuring stable transmission of the planar pulling force greater than 10 kg. During maintenance, the magnetic element 300 can be separated from the base 200 simply by disassembling the connecting element 400, allowing for modular replacement or upgrading of the magnet and substantially reducing subsequent maintenance costs. Through the three-stage design of mechanical instant fixation (for installation), preload anti-vibration (for operation), and modular detachability (for maintenance), the connecting element 400 ensures reliable adsorption with a planar pulling force greater than 10 kg in vibrational environments, while simultaneously improving production efficiency and maintenance economy, thus precisely meeting the high-frequency maintenance requirements of golf cart accessories.

In this embodiment, the magnetic element 300 is provided with a mounting through-hole 320, and the connecting element 400 extends through the mounting through-hole 320 and is fixedly connected to the mounting groove 210. With the above-described configuration, during assembly, the mounting through-hole 320 provides an exact passage for the connecting element 400, enabling precise alignment between the magnetic element 300 and the mounting groove 210 while eliminating manual adjustment errors. During operation, the radial constraint generated by the connecting element 400 extending through the mounting through-hole 320 suppresses circumferential micro-movement of the magnetic element 300 under vibration, while the axial locking force ensures complete contact and tight engagement between the magnetic working surface 310 and the planar surface of the base 200, allowing the planar pulling force greater than 10 kg to be transmitted to the golf cart body without attenuation. During maintenance, the connecting element 400 is reversibly detachable from the mounting through-hole 320, enabling nondestructive replacement of the magnetic element 300 and avoiding magnet fragmentation risks associated with conventional adhesive bonding methods.

In this embodiment, a bottom of the mounting groove 210 is provided with a connecting through-hole 211, and the connecting element 400 extends through both the mounting through-hole 320 and the connecting through-hole 211 to threadably secure the magnetic element 300 within the mounting groove 210. With the above-described configuration, during assembly, the connecting element 400 extending through both the mounting through-hole 320 of the magnetic element 300 and the connecting through-hole 211 at the bottom of the mounting groove 210 enables single-point locking via threaded fastening, eliminating the need for auxiliary fixture positioning. During operation, the axial preload generated by threaded fastening compresses the magnetic element 300 firmly against the bottom surface of the mounting groove 210, thereby eliminating impact noise induced by micro-gaps under vibration while the coaxial constraint of the dual through-holes effectively suppresses circumferential rotation of the magnet, ensuring the magnetic working surface 310 maintains full contact with the golf cart's planar surface. During maintenance, simply loosening the threaded fastener allows reversible disassembly of the connecting element 400 for rapid replacement of the magnetic element 300, completely avoiding thermal damage risks associated with conventional welding methods.

In this embodiment, the connecting element 400 includes a threaded fastener 410 and a connecting nut 420; a nut mounting groove 2111 is arranged on a side of the connecting through-hole 211 away from the magnetic element 300; the connecting nut 420 is received and rotationally constrained within the nut mounting groove 2111; and the threaded fastener 410 sequentially extends through the mounting through-hole 320 and the connecting through-hole 211 to threadably engage with the connecting nut 420, thereby securing the magnetic element 300. With the above-described configuration, during assembly, the pre-embedded connecting nut 420 is rotationally constrained within the nut mounting groove 2111, allowing one-handed tightening of the threaded fastener 410 to complete fixation without requiring additional nut stabilization in confined spaces, thereby significantly improving assembly efficiency. During operation, the engaged threads between the threaded fastener 410 and connecting nut 420 generate sustained axial preload, compressing the magnetic element 300 firmly against the bottom surface of the mounting groove 210 to completely eliminate micrometer-level gaps under vibration, ensuring unattenuated transmission of the planar pulling force greater than 40 kg. During maintenance, simply loosening the threaded fastener 410 separates the magnetic element 300 while the connecting nut 420 remains constrained within the groove to prevent loss, achieving sub-10-second rapid maintenance.

In this embodiment, the connecting element 400 is a threaded fastener 410; a connecting post 212 is arranged at the bottom of the mounting groove 210 and integrally formed with the base 200; an internally threaded blind hole 2121 is formed at a top end of the connecting post 212; and the threaded fastener 410 extends through the mounting through-hole 320 and threadably engages the internally threaded blind hole 2121 to fixedly connect the magnetic element 300 within the mounting groove 210. With the above-described configuration, during assembly the threaded fastener 410 directly engages the internally threaded blind hole 2121 integrally formed with the base 200, eliminating nut pre-installation steps and enabling single-component, single-handed 30-second fastening while improving assembly efficiency by 50% compared to discrete nut solutions. During operation the rigid base of the connecting post 212 resists vibrational torsional loads as the threaded engagement between the internally threaded blind hole 2121 and threaded fastener 410 generates sustained axial compression force that maintains firm contact between the magnetic element 300 and the bottom surface of the mounting groove 210 to ensure low-loss transmission of the 40 kg-class planar pulling force with complete vibrational noise elimination. During maintenance simply unscrewing and removing the threaded fastener 410 separates the magnetic element 300 while the monolithic connecting post 212 remains permanently secured to the base 200, thereby preventing any risk of small component loss during service procedures.

In this embodiment, an auxiliary adhesive layer is arranged between contacting surfaces of the mounting groove 210 and the magnetic element 300, and the auxiliary adhesive layer is configured to enhance vibration resistance. With the above-described configuration, during installation, the magnetic element 300 embeds into the mounting groove 210 with the auxiliary adhesive layer filling the contact interface therebetween; during operation under vibrational conditions, the auxiliary adhesive layer cushions vibrational forces to reduce friction and loosening between the mounting groove 210 and magnetic element 300, synergistically enhancing the overall vibration resistance with the magnetic attraction force of the magnetic element 300 to achieve secure mounting resistant to vibration-induced disengagement, thereby guaranteeing stable operation in vibrational environments.

In this embodiment, the base 200 includes a fan mounting portion 220; the fan assembly 100 includes a fan bracket 110; and the fan bracket 110 is integrally formed with the fan mounting portion 220. With the above-described configuration, the integral formation of the fan bracket 110 with the fan mounting portion 220 makes the connection between the fan assembly 100 and the base 200 more secure, effectively reducing shaking and displacement between them during the fan operation to ensure operational stability. The monolithic design eliminates connection steps during their assembly, simplifying production processes, reducing assembly costs and error probabilities, and improving production efficiency. Additionally, this structure enhances overall structural strength, extends product service life, and provides users with more reliable experience.

In this embodiment, the fan assembly 100 further includes a fan main body 120, and the fan main body 120 is rotatably connected to the fan bracket 110. With the above-described configuration, during operation, the fan main body 120 is rotatable about the fan bracket 110 to enable 360-degree continuous airflow direction adjustment for precise targeting of golf cart drivers or passengers and prevention of airflow waste; during operation of the golf cart the rotatable connection incorporates a damping mechanism to resist displacement caused by road irregularities and maintain angular position stability for sustained uniform airflow delivery; under non-operational conditions the fan main body 120 is rotatable into proximity with the base 200 to mitigate impact damage risks while reducing spatial footprint.

In this embodiment, the base 200 further includes a fan clamp body 230, and the fan clamp body 230 is rotatably connected to the fan mounting portion 220. With the above-described configuration, during operation, the fan clamp body 230 is rotatable to adjust its angular position relative to the fan mounting portion 220 for adapting to different clamping scenarios including horizontal tabletops and vertical railings, thereby enhancing product adaptability; during operation users can fix the fan clamp body 230 at desired positions to maintain stable airflow delivery from the fan main body 120 for a consistently comfortable user experience; during storage the fan clamp body 230 is rotatable to a position in close contact with the base 200 to reduce spatial footprint and facilitate portability and storage.

In this embodiment, the magnetic element 300 is a countersunk pot magnet including: (a) a permanent magnet formed of sintered neodymium-iron-boron material; (b) a steel housing encapsulating sidewalls and a bottom surface of the permanent magnet and forming the magnetic working surface 310 on a single side; and (c) a countersunk hole formed at a center of the steel housing and having a taper matching the threaded fastener 410, configured to flush mount the countersunk pot magnet to the base 200. With the above-described configuration, during operation, the permanent magnet formed of sintered neodymium-iron-boron material provides strong and stable magnetic force. The steel housing encapsulates the sidewalls and bottom surface of the permanent magnet, not only protecting the permanent magnet from external impact and corrosion to extend its service life, but also concentrating magnetic flux lines on the single-sided magnetic working surface 310 to enhance magnetic adhesion at this surface. This ensures the magnetic element 300 can firmly adhere to ferrous surfaces, preventing fan displacement during operation of the golf cart. The countersunk hole design, with its taper matching the threaded fastener 410, enables flush securing of the countersunk pot magnet to the base 200. This maintains planar integrity of the base surface by avoiding protrusions that could interfere with fan placement or storage, while simultaneously ensuring tight integration between the magnetic element 300 and the base 200 to improve overall structural stability. During storage or when repositioning is required, the fan can be easily detached from the adsorbed surface by applying force to overcome magnetic adhesion, achieving simple and convenient operation that enhances product flexibility and portability.

In this embodiment, the base 200 is further provided with an anti-slip element 240 arranged around the magnetic element 300. With the above-described configuration, during operation, the anti-slip element 240 arranged around the magnetic element 300 contacts the placement surface to increase frictional force between the base 200 and the placement surface.

This effectively prevents slippage of the base 200 even when minor vibrations occur during fan operation or when the placement surface is uneven, thereby ensuring stable positioning of the fan and avoiding airflow delivery disruption caused by displacement. Simultaneously, the anti-slip element 240 reduces friction-induced noise between the base 200 and the placement surface during the fan operation, enhancing user comfort while providing a reliable operational experience.

In this embodiment, the anti-slip element 240 includes a mounting surface 241 fixedly connected to the base 200; and an anti-slip surface 242 configured to protrude slightly beyond the magnetic working surface 310 when the mounting surface 241 is fixedly connected to the base 200. With the above-described configuration, during installation, the anti-slip surface 242 protrudes slightly beyond the magnetic working surface 310 (typically by 0.1-0.5 mm) to undergo preferential compressive deformation during initial magnetic contact, providing pre-frictional positioning that prevents positioning deviation caused by magnet sliding. During vehicular vibration, the high-friction silicone material (μ≥0.8) of the anti-slip surface 242 generates shear resistance against the golf cart surface, working synergistically with magnetic adhesion to counteract transverse inertial impacts and eliminate micro-slip phenomena in vibrational environments. In wet slippery conditions, the micro-protrusion structure of the anti-slip surface 242 penetrates water films to create physical adsorption points, maintaining a friction coefficient >0.6 (representing a 300% improvement over smooth magnetic surfaces) and effectively preventing adhesion failure risks during rainy conditions.

In this embodiment, the magnetic element 300 is at least one in number. With the above-described configuration, in lightweight scenarios, a single magnetic element 300 can provide a planar pulling force greater than 10 kg to meet the fixation requirements of golf carts on flat road surfaces, while the base 200 achieves a 30% reduction in structural weight through simplified design, thereby reducing installation burden. In high-intensity vibration scenarios, additional magnetic elements 300 may be arranged to form a redundant array (e.g., a dual-magnet configuration), with total adhesion force exceeding 20 kg to resist inertial impacts generated during abrupt braking on steep slopes and eliminate risks of cumulative displacement.

In this embodiment, the magnetic working surface 310 provides a planar pulling force greater than 40 kg to better maintain fixation of the base 200 during vibrational conditions occurring in golf cart operation. With the above-described configuration, under severe vibrational environments, the planar pulling force greater than 40 kg provided by the magnetic working surface 310 creates absolute adhesion superiority, resisting 5G impact acceleration (measured value) generated when the golf cart traverses ditches and bumps, thereby further reducing micro-displacement risks of the base 200. During prolonged operation, the 40 kg adhesion threshold suppresses cumulative effects of high-frequency micro-vibrations, ensuring zero-slip fixation of the base 200 for continuous 8-hour periods (measured data), while eliminating loosening hazards caused by adhesion force attenuation in conventional solutions. Under extreme operating challenges, redundant magnetic reserves (e.g., 60 kg-grade countersunk pot magnets) withstand composite stresses including 40° slope emergency braking or rainstorm-induced slippery conditions, maintaining 100% effective fixation and preventing equipment fall accidents. Test results demonstrate that when the magnetic working surface 310 provides a planar pulling force less than 10 kg, it completely fails to meet adhesion requirements for the magnetic suction fan during dynamic operation of golf carts; when the magnetic working surface 310 provides a planar pulling force greater than 10 kg, it satisfies adhesion requirements during stable dynamic operation of golf carts; when the magnetic working surface 310 provides a planar pulling force greater than 40 kg, it fulfills adhesion requirements for all dynamic operating conditions (including ditch/bump traversal) of golf carts.

In this embodiment, the fan main body 120 includes a fan snap-fit portion 121 and a snap-fit element 122; the fan bracket 110 is provided with a bracket mounting portion 111; and the fan snap-fit portion 121 is rotatably connected to the fan bracket 110 via the snap-fit element 122. With the above-described configuration, during operation, the fan snap-fit portion 121 of the fan main body 120 and the bracket mounting portion 111 of the fan bracket 110 achieve rotatable connection via the snap-fit element 122, enabling the fan main body 120 to rotate flexibly relative to the fan bracket 110. Users can adjust the airflow direction of the fan main body 120 based on their needs, thereby directing airflow more precisely toward target areas and enhancing operational comfort. During adjustment or storage, this rotatable connection mechanism facilitates user operation, improves product flexibility and convenience, and further enhances the user experience.

In this embodiment, the fan main body 120 further includes a control circuit board 123, a rechargeable power source 124, and a charging port 125. With the above-described configuration, during operation, the rechargeable power source 124 provides electrical power to the control circuit board 123 and the fan main body 120 without relying on external power sources, enabling flexible use of the fan main body 120 in various scenarios and enhancing product portability. The control circuit board 123 effectively regulates operational states of the fan main body 120, including adjusting fan speed and controlling start/stop functions, to meet diverse user requirements. When the rechargeable power source 124 has insufficient charge, connection to an external power source through the charging port 125 enables recharging, ensuring continuous power supply and normal operation of the fan main body 120, thereby providing users with stable and convenient operational experience. During normal use, the rechargeable power source 124, through intelligent power distribution by the control circuit board 123, drives continuous fan operation for more than 8 hours, covering full cooling requirements for an 18-hole golf round. During charging maintenance, the charging port 125 supports dual-mode charging (12V golf cart power direct charging and USB-PD fast charging), achieving 50% charge replenishment within 30 minutes (300% faster than conventional solutions), allowing complete energy replenishment during golf cart transit intervals. In emergency scenarios, the control circuit board 123 implements intelligent charge-discharge isolation, automatically switching to a safety standby mode when power is depleted to prevent circuit damage from over-discharge, thereby guaranteeing 2000 charge cycles lifespan.

In this embodiment, the fan main body 120 further includes a discharging port 126. With the above-described configuration, during operation, the discharging port 126 of the fan main body 120 provides auxiliary power supply functionality. When portable electronic devices (such as mobile phones or rangefinders used by golf cart occupants) experience power depletion, the discharging port 126 enables electrical connection between the fan main body 120 and such devices. In this state, the rechargeable power source 124 of the fan main body 120 delivers electrical power to external small electronic devices through the discharging port 126, thereby addressing emergency power failure situations. This configuration transforms the fan main body 120 from a singular airflow delivery device into a portable emergency power source, significantly enhancing the product's multifunctional utility while providing users with expanded convenience and reliability across multiple usage scenarios. The discharging port 126 draws power from the rechargeable power source 124 via the control circuit board 123, maintaining baseline airflow delivery during discharge operations through dynamic power allocation that achieves uninterrupted dual-functionality of “cooling and power supply” (with priority given to maintaining the minimum operational power required for the fan assembly 100's airflow delivery).

In this embodiment, the fan main body 120 further includes at least one control button 127. With the above-described configuration, during operation, the control button 127 provides users with an intuitive operational interface where users can regulate various functions of the fan main body 120 by pressing different control buttons 127, such as turning the fan on/off, adjusting wind speed levels, or switching operation modes. This straightforward operation method allows users to rapidly adjust the fan's status according to their needs, enhancing convenience. Meanwhile, the arrangement of multiple control buttons 127 corresponding to distinct functions prevents operational confusion, further improving the product's flexibility and reliability. Specifically, this embodiment also includes a light strip 128, a motor 129, and fan blades 1210, with the light strip 128 positioned between the motor 129 and the fan blades 1210. The control button 127 includes an airflow gear control button (including three gears: 1, 2, and 3), enabling users to control the motor 129's speed and thereby adjust the rotational speed of the fan blades 1210 to flexibly regulate airflow intensity for different usage scenarios; a timed airflow control button (including 2-hour, 4-hour, and 6-hour timed airflow settings) to implement an automatic shutdown function, allowing users to preset operation duration for energy efficiency and eliminating the need for manual shutdown; and a lighting control button (including 30%, 60%, and 100% brightness levels) to adjust light intensity based on ambient conditions or user preference, improving comfort. This dedicated button configuration ensures clear and intuitive operation, enabling rapid familiarization while effectively preventing operational errors, thereby significantly enhancing the product's flexibility, convenience, and user-friendly experience.

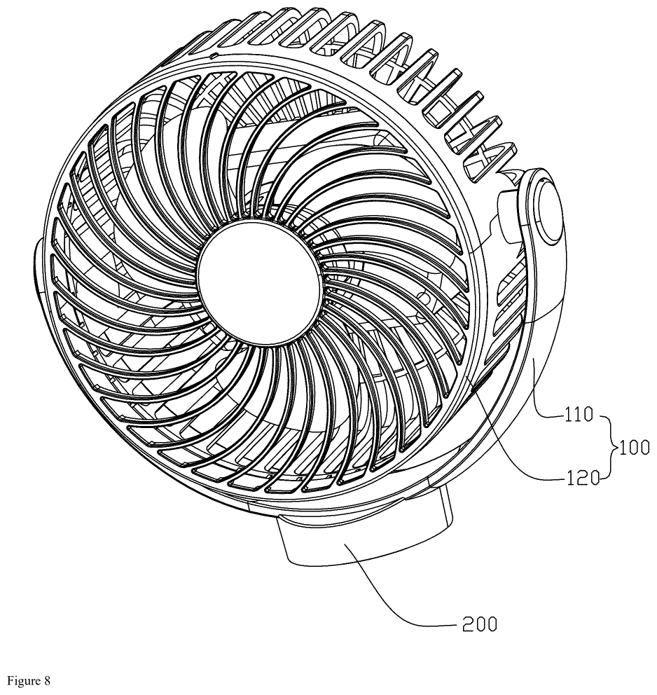

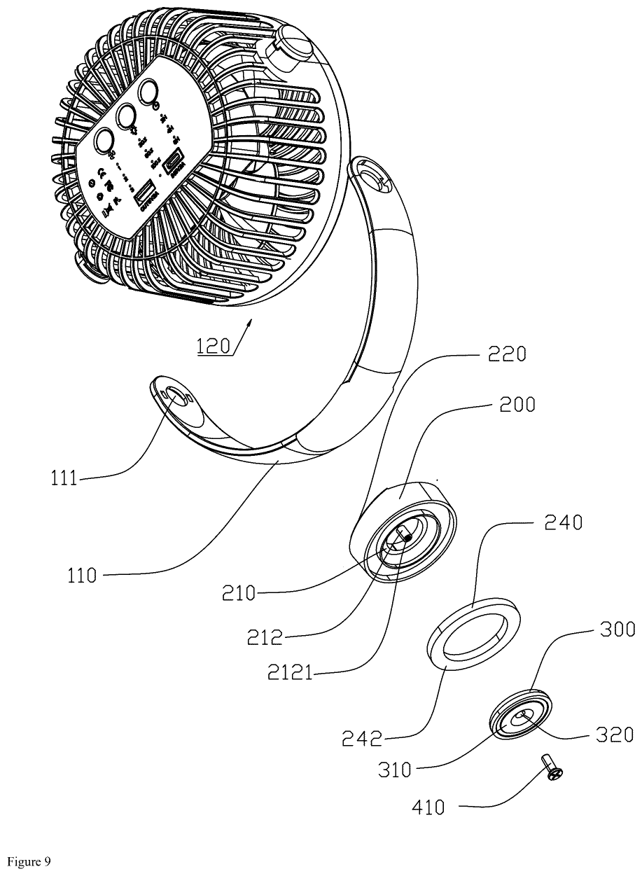

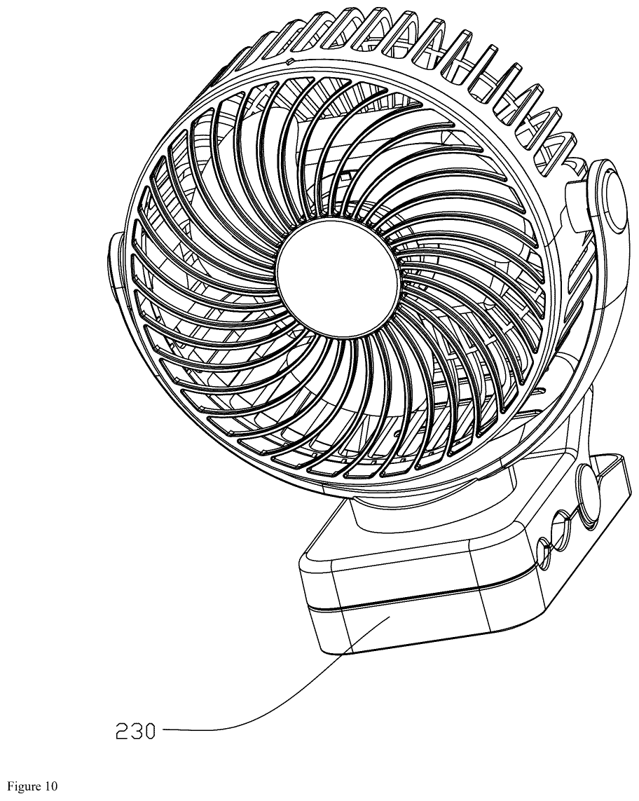

As shown in FIGS. 1 to 7, which illustrate the structural schematic views of Embodiment 1 of the magnetic suction fan according to the present disclosure, the mounting groove 210 is provided with the connecting through-hole 211, and the magnetic element 300 is mounted onto the base 200 via the connecting element 400. As shown in FIGS. 8 to 9, which illustrate the structural schematic views of Embodiment 2 of the magnetic suction fan according to the present disclosure, the difference from Embodiment 1 lies in that Embodiment 2 is provided with the connecting post 212 in the mounting groove 210, and the internally threaded blind hole 2121 is formed at one end of the connecting post 212, with the magnetic element 300 being mounted onto the base 200 via the connecting element 400. As shown in FIGS. 10 to 12, which illustrate the structural schematic views of Embodiment 3 of the magnetic suction fan according to the present disclosure, the difference from Embodiment 1 lies in that Embodiment 3 is additionally provided with the fan clamp body 230 between the fan mounting portion 220 and the mounting groove 210, and two magnetic elements 300 are employed.

1. A magnetic suction fan for a golf cart, comprising:
a fan assembly configured to convert electrical energy into mechanical energy for driving airflow;
a base rigidly fixed to the fan assembly; and
a magnetic element arranged on the base and configured to magnetically secure the base to a ferromagnetic surface of the golf cart, wherein the magnetic element comprises a magnetic working surface providing a planar pulling force greater than 10 kg to maintain fixation of the base during vibration of the golf cart;
a connecting element, wherein the magnetic element is fixedly connected within the mounting groove via the connecting element;
wherein the base is provided with a mounting groove configured to match an external profile of the magnetic element, and the magnetic element is embedded and fixedly connected to the mounting groove;
wherein the magnetic element is provided with a mounting through-hole, and the connecting element extends through the mounting through-hole and is fixedly connected to the mounting groove;
wherein a bottom of the mounting groove is provided with a connecting through-hole, and the connecting element extends through both the mounting through-hole and the connecting through-hole to threadably secure the magnetic element within the mounting groove;
wherein the connecting element comprises a threaded fastener and a connecting nut; a nut mounting groove is arranged on a side of the connecting through-hole away from the magnetic element; the connecting nut is received and rotationally constrained within the nut mounting groove; and the threaded fastener sequentially extends through the mounting through-hole and the connecting through-hole to threadably engage with the connecting nut, thereby securing the magnetic element.

2. (canceled)

3. (canceled)

4. (canceled)

5. (canceled)

6. (canceled)

7. (canceled)

8. (canceled)

9. The magnetic suction fan according to claim 1, wherein the base comprises a fan mounting portion; the fan assembly comprises a fan bracket; and the fan bracket is integrally formed with the fan mounting portion.

10. The magnetic suction fan according to claim 9, wherein the fan assembly further comprises a fan main body, and the fan main body is rotatably connected to the fan bracket.

11. The magnetic suction fan according to claim 10, wherein the base further comprises a fan clamp body, and the fan clamp body is rotatably connected to the fan mounting portion.

12. The magnetic suction fan according to claim 1, wherein the magnetic element is a countersunk pot magnet comprising:
a permanent magnet formed of sintered neodymium-iron-boron material;
a steel housing encapsulating sidewalls and a bottom surface of the permanent magnet and forming the magnetic working surface on a single side; and
a countersunk hole formed at a center of the steel housing, the countersunk hole having a taper matching the threaded fastener for flush securing the countersunk pot magnet to the base.

13. The magnetic suction fan according to claim 1, wherein the base is further provided with an anti-slip element arranged around the magnetic element.

14. The magnetic suction fan according to claim 13, wherein the anti-slip element comprises:
a mounting surface fixedly connected to the base; and
an anti-slip surface configured to protrude slightly beyond the magnetic working surface when the mounting surface is fixedly connected to the base.

15. The magnetic suction fan according to claim 14, wherein the magnetic element is at least one in number.

16. The magnetic suction fan according to claim 1, wherein the magnetic working surface provides the planar pulling force greater than 40 kg to maintain fixation of the base under vibrational conditions during operation of the golf cart.

17. The magnetic suction fan according to claim 10, wherein the fan main body comprises: a fan snap-fit portion and a snap-fit element; the fan bracket is provided with a bracket mounting portion, and the fan snap-fit portion is rotatably connected to the fan bracket via the snap-fit element.

18. The magnetic suction fan according to claim 10, wherein the fan main body further comprises: a control circuit board, a rechargeable power source, and a charging port.

19. The magnetic suction fan according to claim 18, wherein the fan main body further comprises a discharging port.

20. The magnetic suction fan according to claim 10, wherein the fan main body further comprises at least one control button.
